(19) United States
(12) Patent Application Publication
(10) Pub. No.: US 2009/0040281 A1
(43) Pub. Date: Feb. 12, 2009

(54) DEVICE FOR REFILLING AN INK CARTRIDGE FOR AN INKJET PRINTER

(75) Inventor: Daniel Sulser, Wald (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: Pelikan Hardcopy Production AG, Egg (CH)

(21) Appl. No.: 12/186,624

(22) Filed: Aug. 6, 2008

(30) Foreign Application Priority Data
Aug. 6, 2007 (DE) 102007037029.8
Aug. 24, 2007 (DE) 102007040108.8

(51) Int. Cl. B41J 2/175

(52) U.S. Cl. 347/86

(57) ABSTRACT

Device (10) for refilling an ink cartridge (1) for an inkjet printer, for example having a print head (16) comprising nozzles, the nozzles of the print head (16) being directly in fluid connection with an ink reservoir element arranged inside the ink cartridge (1). The device has an ink-filled container (11) with an air-inlet opening (7) on the one hand and a further opening (18) on the other hand, through which there extends a capillary element (4), which is arranged to be brought into fluid connection with the ink (19) and to which the ink cartridge (1) or the ink reservoir element thereof is dockable, with establishment of a capillary fluid connection. The air-inlet opening (7) provided in the ink container (11) is openable only on docking of the ink cartridge (1). The ink container (11) also has an ink outlet (17) to the capillary element (4), which outlet optionally is likewise openable only on docking of the ink cartridge (1).

### CROSS-REFERENCE TO RELATED APPLICATIONS

This application claims the benefit of DE 10 2007 037 029.8, filed Aug. 6, 2007, and DE 10 2007 040 108.8, filed Aug. 24, 2007, which are both incorporated herein by reference as if fully set forth.

### BACKGROUND

The present invention relates to a device for refilling an ink cartridge for an inkjet printer having a print head with nozzles or having an ink outlet opening couplable to the ink supply of an inkjet head, with either the nozzles of the print head being directly in fluid connection or, in the case of an ink outlet opening couplable to the ink supply of an inkjet head, in which the ink outlet opening is in fluid connection, especially by way of a wick and/or a valve or a direct fluid connection, with an ink reservoir element arranged inside the ink cartridge and including, for example, absorbent material or a mechanism that generates negative pressure, having an ink-filled container with an air-inlet opening on the one hand and a further opening on the other hand, through which there extends a capillary element which is arranged to be brought into fluid connection with the ink and to which the ink cartridge or the ink reservoir element thereof is dockable, with establishment of a capillary fluid connection.

The present case therefore relates to the refilling of an ink cartridge for an inkjet printer with ink, it being necessary to make a distinction between cartridges having integrated print heads on the one hand and cartridges having an ink outlet opening couplable to the ink supply opening of an inkjet head. The afore-mentioned print heads comprise a multiplicity of very fine jet nozzles through which the ink is transferred to a print substrate. In the case of multicolor ink cartridges, a predetermined number of jet nozzles is associated with a predetermined color. In the case of cartridges having an ink outlet opening couplable to the ink supply of an inkjet head there is generally arranged therein a wick which is in fluid connection with an ink reservoir element arranged inside the ink cartridge and consisting of absorbent material.

In the case of cartridges having integrated print heads, the afore-mentioned nozzles are directly in fluid connection with the ink reservoir element arranged inside the cartridge. The ink reservoir element is either made of fibre material or made of a foam material. As this is a feature known per se, a more detailed description thereof is unnecessary here. Also now available are other “mechanisms that generate negative pressure” which ensure that a metered amount of ink is supplied to the nozzles or to the ink outlet opening. Because those mechanisms also have a reservoir function, they are likewise to be included under the term “ink reservoir element” hereinbelow.

In order to be refilled with ink, cartridges having integrated print heads have to be very carefully broken open and re-closed. The effort involved is correspondingly great and is not cost-effective for cartridges having a low capacity.

Furthermore, for cartridges of the kind mentioned above there are also known so-called injection refill systems by which an original cartridge can be refilled. The sets in question comprise a drill, a hot-glue gun, at least four syringes with a cannula, ink, a conventional rubber band and closure means. The afore-mentioned systems are commercially available. They are distinguished, however, by being awkward to handle and by requiring disproportionately great expense in terms of materials and tools.

As an alternative, so-called “compatible cartridges” are available which have no electronic components. The electronic components therefore have to be transferred from the empty original cartridge. That too requires dexterity and tools as well as adhesive.

Cartridges having an integrated print head are in practice purchased very expensively on the so-called recycling market. They are then mechanically opened, cleaned and provided with a new ink reservoir element, for example a sponge or the like. The cartridge is then filled with replacement ink and closed again. All those procedures can in effect be carried out only by a special refill company, that is to say not by the user himself.

In respect of the prior art, reference is also made to DE 197 37 177 A1 and WO 2004/091919 A1. A device for refilling an ink cartridge having an ink outlet opening couplable to the ink supply of an inkjet head in accordance with the preamble of claim 1 can be found in those documents.

In that prior art, however, no steps are taken to avoid unintentional leakage from the ink container, whether it be by way of the air-inlet opening or by way of the capillary element.

### SUMMARY

Accordingly, the present invention is based on the objective of providing a device for refilling an ink cartridge for an inkjet printer which is not only simple to produce and, in particular, simple to handle, so that it can also readily be managed by the end user, but is also distinguished by the fact that unintentional leakage from the ink container is avoided, it being pointed out that the device should be equally effective for cartridges having integrated print heads and for cartridges having an ink outlet opening couplable to the ink supply of an inkjet head.

This objective is met according to the invention, with advantageous developments and structural details being described in detail in the description and claims which follow. In that respect, reference is made especially also to the features in accordance with the invention having the purpose of avoiding unintentional escape of ink from the ink container of the device.

The at least one air-outlet channel of one preferred embodiment ensures that the capillary element is not impeded by enclosed air during refilling of an ink cartridge. Without such an air-outlet channel it is possible that the capillary element will absorb from above residual ink from the ink cartridge being filled and thus prevent air present in the capillary element from escaping, with the result that further ink cannot be absorbed from below from the ink container.

The features in accordance with another preferred embodiment relate to a special positioning and clamping technique for the ink cartridge on the refilling device, and moreover matched to the shape of the ink cartridge, the positioning and clamping being effected so that a capillary connection between the capillary element and the ink reservoir element arranged inside the cartridge is ensured.

Further preferred embodiments relate to features suited to multicolor ink cartridges, that is to say ink cartridges having at least two ink chambers for holding ink of different colors. Those features too are not necessarily dependent upon the measures taken against leakage in accordance with the invention.

Finally, it should also be mentioned that protection is being claimed also for the features in accordance with another preferred embodiment that is directed to capillary decoupling of the capillary element from the ink cartridge positioning surface adjacent thereto, the decoupling especially being in the form of a peripheral depression. Specifically, the capillary element is bounded by a rib extending around the capillary element at a short distance therefrom, which rib separates from one another an annular gap facing the capillary element on the one hand and a peripheral groove, remote from the capillary element, in the positioning surface. Excess ink can accumulate in the afore-mentioned annular gap, particularly in the region between the rib and the underside of the ink cartridge or of a print head having jet nozzles associated with the ink cartridge resting on the rib. As a result of the outer peripheral groove bounding the rib, however, the capillary connection between the afore-mentioned region and the remainder of the positioning surface of the ink container of the refilling device is broken. Accordingly, ink also does not pass to the associated surface of the ink cartridge or the print head. Contamination of the inserted cartridge in the region outside the afore-mentioned rib is reliably avoided.

The device according to the invention therefore contains a so-called “capillary refill system”. For filling, the capillary absorption force of the ink cartridge being filled or of the ink reservoir element arranged therein is exploited. The system has an ink container, which is generally of flat construction, of sufficiently high stability, which container has a capillary element, especially in the form of a wick, arranged to be brought into fluid connection with the replenishing ink. That capillary element or that wick passes out of the container on the upper side thereof and is arranged so that a capillary connection is established with the mounted ink cartridge, that is to say either with the nozzles of the integrated print head or with the ink outlet opening couplable to the ink supply of an inkjet head. The container has an air-inlet or pressure-equalisation opening which is not opened until the ink cartridge is docked. It is thus ensured that ink can be absorbed, unimpeded, by capillary action from the mounted ink cartridge. Such an air-inlet opening can at the same time be used for filling the ink container.

According to the invention, therefore, the ink reservoir element of the ink cartridge can be refilled with a portion of ink in a simple way, and moreover without the use of tools and within a few minutes. There is also no risk of the user's becoming contaminated with ink.

Using the device according to the invention, portions of ink of different colors can be made commercially available. It is a disposable article. OEM cartridges can be filled repeatedly by means of the device according to the invention. Filling can also be effected by means of the nozzles of integrated print heads.

No additional pressure is necessary for filling the ink cartridge. The ink reservoir element located in the cartridge, for example a sponge or fibre material or the like, absorbs ink until saturated. It is therefore also impossible to overfill the cartridge. As already mentioned, the device according to the invention is also constructed so that contact with free ink is ruled out, so that any associated risk of contamination of the user or the environment is avoided. There is no risk of injury, as in the case, for example, of injection refill systems. In addition, using the device according to the invention an ink cartridge can be filled considerably more quickly than, for example, using a syringe, where the cartridge first has to be drilled open before it can be refilled. After refilling, the drill hole in question has to be closed again. All those procedures take a relatively long time and require not inconsiderable dexterity. Moreover, special tools are required. All those disadvantages are avoided using the device according to the invention. The size of the portions of ink is such that no residual ink is left over in the ink container according to the invention.

Tests have shown that the ink reservoir element of the ink cartridge is completely full after an absorption time of from about 30 minutes to a maximum of 60 minutes. That is to say, the ink reservoir element is saturated after that time.

The air-inlet or pressure-equalisation opening already mentioned is preferably so dimensioned that the external blocking pressure is always greater than the emptying pressure, so that ink should be unable to escape from the container through the mentioned opening. If the ink container is moved somewhat clumsily, however, there is nevertheless a risk of leakage. In order also to avoid that risk, the air-inlet opening is associated with a valve which is openable only on docking of an ink cartridge.

According to the invention, the ink outlet associated with the capillary element is also associated with a valve which unblocks the fluid connection between the replenishing ink in the container of the device and the capillary element only when an ink cartridge has been docked.

The capillary element, which is preferably in the form of a bar-like wick or in the form of a brick-shaped pad, is so dimensioned and arranged that it can simply be brought into contact either with the nozzles provided in the print head of the ink cartridge or with a wick arranged in the ink outlet opening of the ink cartridge, in the latter case the wick of the ink container being made of a softer or more flexible material than the wick of the ink cartridge, so that the wick of the ink cartridge is not deformed by the contact with the wick of the ink container. That is important in order to safeguard the fluid connection between the ink cartridge and the ink supply of an inkjet head also after the cartridge has been refilled.

### BRIEF DESCRIPTION OF THE SEVERAL VIEWS OF THE DRAWINGS

Further advantages and structural details of the refilling device according to the invention are described below with reference to an exemplary embodiment shown in the drawings.

FIG. 1 is a perspective view, obliquely from above, of a refilling device according to the invention;

FIG. 2 shows the device according to FIG. 1 in cross-section;

FIG. 3 shows the device according to FIG. 1 in longitudinal section;

FIG. 4 shows the device according to FIG. 1 in longitudinal section, depicting the docking of an ink cartridge having an integrated print head;

FIG. 5 is a view corresponding to FIG. 4 showing the ink cartridge docked;

FIG. 6 is a view corresponding to FIG. 4 or 5, depicting the removal of a refilled ink cartridge;

FIG. 7 is a view corresponding to FIG. 5 in the case of an ink cartridge provided with a corner projection, to which the refilling device is appropriately matched for the purposes of docking the ink cartridge.

### DETAILED DESCRIPTION OF THE PREFERRED EMBODIMENTS

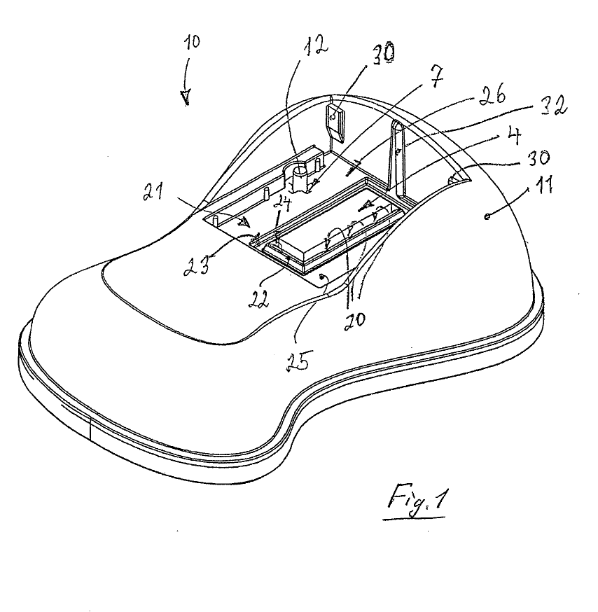

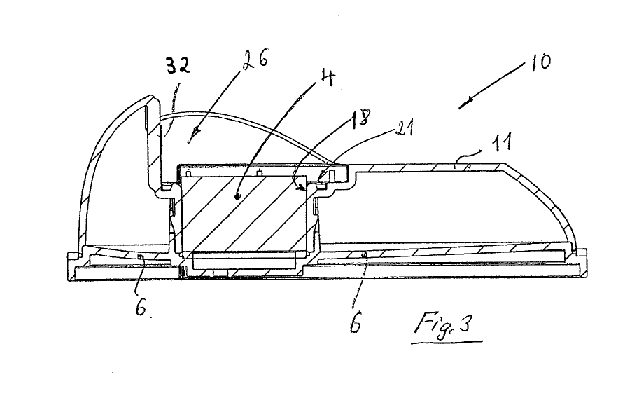

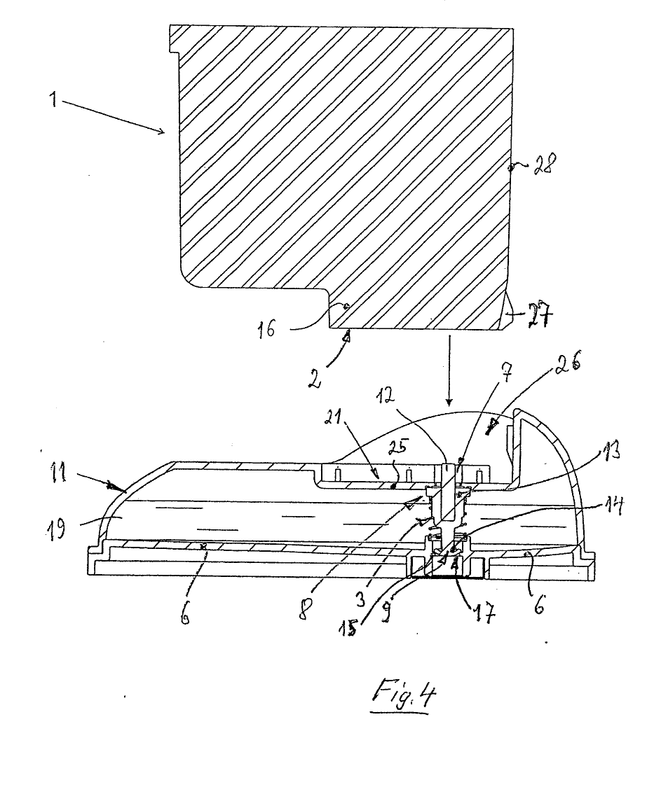

FIGS. 1 to 6 show different views and sections of a first embodiment of a device 10 for refilling an ink cartridge 1 for an inkjet printer having a print head 16 comprising nozzles (see FIG. 4 to 6), the nozzles of the print head 16 in the embodiment shown being directly in fluid connection with an ink reservoir element made of absorbent material arranged inside the ink cartridge. That ink reservoir element is not shown specifically in FIGS. 4 to 6 because it is a feature known per se. The same is also true of the integrated print head having nozzles. The device 10 comprises a container 11 filled with ink 19 (see FIG. 4) having a pressure-equalisation or air-inlet opening 7 on the one hand and a further opening 18 through which there extends a capillary element arranged to be brought into fluid connection with the ink 19, the capillary element being in the form of a brick-shaped wick pad 4 to which the ink cartridge 1 or the ink reservoir element thereof is dockable in respect of fluid, that is to say with establishment of a capillary fluid connection.

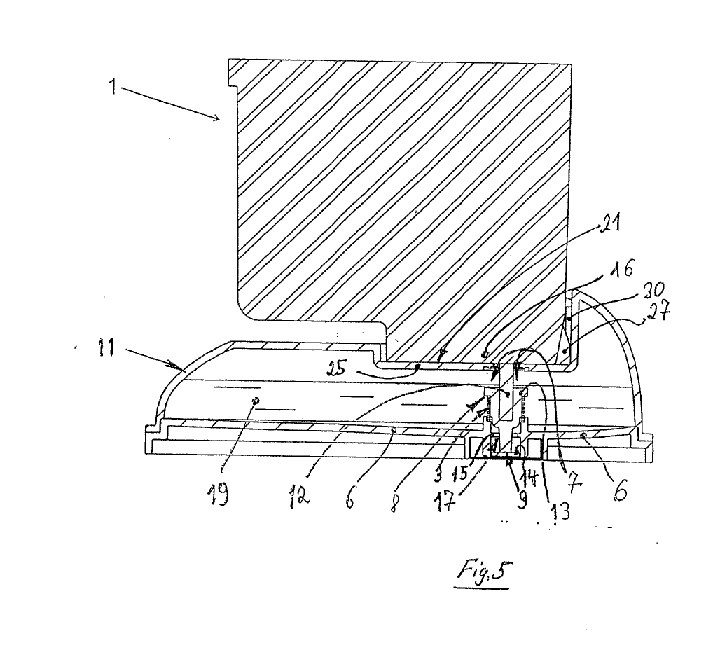

The air-inlet opening 7 provided in the ink container 11 is configured so that it does not open until the ink cartridge 1 is docked in accordance with FIGS. 4 and 5. For that purpose, the air-inlet opening 7 is associated with a valve 8 which is moved into the opening position by the cartridge only on docking of the ink cartridge in accordance with FIG. 5.

The ink container 11 has, furthermore, a separate ink outlet 17 which is provided in the base 6 of the container 11 and opens into a base-side connecting duct 5 to the capillary element 4. That ink outlet 17 is preferably likewise openable only on docking of the ink cartridge 1. For that purpose, the ink outlet 17 is also associated with a valve 9.

In the embodiment shown, the valve 8 associated with the air-inlet opening 7 and the valve 9 associated with the ink outlet 17 have a common valve stem 12 having a valve body 13 associated with the air-inlet opening 7 on the one hand and a valve body 14 associated with the ink outlet 17 on the other hand so that, on docking of the ink cartridge 1, actuation of the valve stem 12 causes the two valve bodies 13 and 14, either simultaneously or in succession, to unblock and open the air-inlet opening 7 (this preferably taking place first) and the ink outlet 17, or vice versa on removal of the ink cartridge 1 from the capillary element 4. That construction is particularly simple because it contains two valves inside a common structural element. That structural element, i.e. the valve stem 12, is advantageously movable from the valve closure position to the valve opening position against the action of a resilient element, in this case against the action of a helical compression spring 3. It is thus ensured that with the removal of the ink cartridge 1 both the air-inlet opening 7 and the ink outlet 17 are closed automatically. Ink 19 still present in the container 11 can then no longer escape from the container 11 even when the device is incorrectly handled.

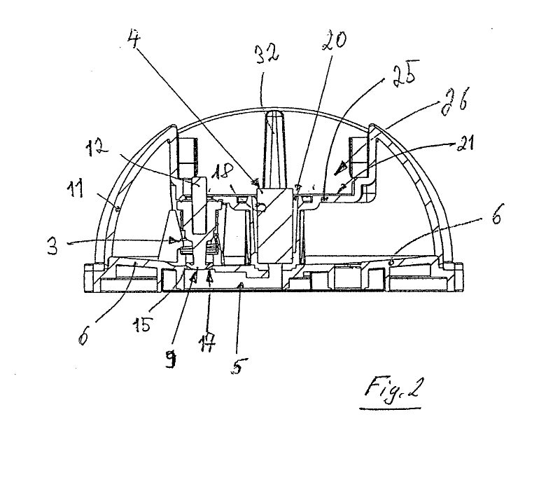

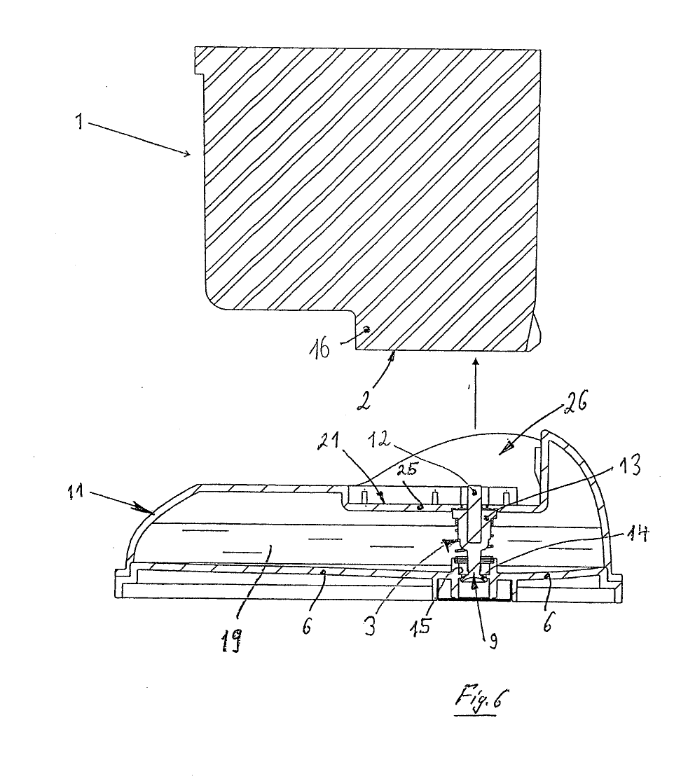

It is also of particular interest that the valve body 14 associated with the ink outlet 17 is in the form of a valve disc made of resiliently flexible material. The peripheral rim of the resiliently flexible valve disc 14 is associated with a peripheral rib 15 inside the ink outlet 17, and before the first use of the device, i.e. before the first actuation of the valve 9 associated with the ink outlet 17, the peripheral rim of the valve disc 14 rests sealingly against the side of the peripheral rib 15 facing the ink cartridge docking side of the container 11, i.e. the upper side thereof (see FIG. 2 and FIG. 4), and after use or after removal of a refilled cartridge 1 rests sealingly against the opposite side, i.e. the lower side, of the peripheral rib 15 (see FIG. 6), and moreover, in the embodiment shown, in each case with the valve disc 14 bulging very slightly into the ink outlet opening 17 bounded by the peripheral rib 15. The valve disc 14 is therefore concavely deformed in the as-delivered state and is convex after the reclosure of the ink outlet 17. That has the advantage that very little force is required to actuate the valve stem 12 and the concave sealing disc closes correspondingly better with increased internal pressure.

In the opened position of the valve 9 associated with the ink outlet 17, in accordance with FIG. 5 the valve disc 14 extends approximately perpendicular to the longitudinal axis of the stem 12, that is to say is approximately flat. In that position, the ink outlet 17 is opened to the maximum extent and a fluid connection is established between capillary element 4 and the ink 19 inside the container 11 by means of the base-side connecting duct 5. That also means, of course, that before the first use of the described refilling device the capillary element is not in contact with ink. The capillary element is not connected to the ink 19 present in the container 11 until a cartridge 1 to be refilled is docked.

As already mentioned at the beginning, the capillary element 4 is associated with at least one air-outlet channel 20, in the case of the embodiment shown with a plurality of air-outlet channels 20, which extend between the capillary element and the container opening 18 surrounding it. They ensure that the capillary element is not impeded by enclosed air when an ink cartridge is being filled. Without such air-inlet channels there is a risk that the capillary element will absorb from above residual ink from the cartridge 1 being refilled and will then prevent the air present in the capillary element from escaping. The air then enclosed in the capillary element prevents replenishing ink from being absorbed from the container 11. The mentioned air-outlet channels, which preferably extend over almost the entire height of the capillary element 4 (see FIG. 2), therefore allow air enclosed inside the capillary element 4 to escape to the outside at the sides. Accordingly, the operability of the capillary element 4 in every phase of the refilling of the ink cartridge 1 is ensured.

Preferably, a plurality of air-outlet channels 20 are distributed uniformly around the periphery of the capillary element 4, as indicated in FIG. 1.

FIG. 1 also shows that the capillary element 4 is decoupled in respect of capillary action from the ink cartridge positioning surface 21 bounding it, more specifically in the form of a peripheral rib 22 between a peripheral depression or groove 23 on the one hand and a peripheral gap 24 towards the capillary element on the other hand. The function of that capillary decoupling has already been explained at the beginning. The rib, together with the outer peripheral groove-like depression, prevents ink from spreading by capillary action along the underside 2 of the docked ink cartridge, especially along the underside of an integrated print head of an ink cartridge. Accordingly, undesirable and, especially, uncontrolled contamination of the ink cartridge during refilling can be avoided.

It should also be mentioned that the base 6 of the container 11 is in the form of a gravitation base, especially sloping towards the ink outlet 17. Accordingly, complete emptying of the ink container 11 during refilling of an ink cartridge 1 is ensured.

Furthermore, it should be pointed out that in the embodiment shown the capillary element 4 extends through the base 25 of a trough-like depression 26 on the upper side of the ink container 11 and, indeed, into the trough-like depression 26, as can be seen very clearly, for example, in FIG. 2 but also in FIG. 1. The upper side of the base 25 of the trough-like depression 26 defines the afore-mentioned positioning surface 21 for the ink cartridge or an integrated print head 16 thereof. The valve stem 12, which has already been mentioned above, also extends upwards through the trough base 25 and limits the air-inlet opening 7 associated with the valve stem 12 (see FIG. 1).

The trough-like depression is also configured so that the ink cartridge or a print head thereof can be exactly positioned and mounted therein. The outline of the trough-like depression 26 corresponds, for example, to the outline of an associated print head 16.

The container 11 of the device containing the replenishing ink 19 can be made at least partly of transparent material, preferably plastics material, in order that both the level and the color of the ink can be identified.

In particular, the container, provided it is configured for multiple filling, can be provided with graduation marks for ascertaining how many portions of ink are still left in the container. Any other kind of level indicator would also be possible, for example in the form of a float having on the upper side of the container a float needle extending through the upper side of the container to the outside with markings indicating the level. In that case the float needle is preferably encapsulated with respect to the external environment so that no sealing problems arise in that respect.

In the embodiment shown, the container 11 is of two-part construction. It consists of an upper part on the one hand and a base part on the other hand. The connecting duct 5 already mentioned is integrated into the base part, while the upper part comprises the trough-like depression 26 together with the associated openings for valve stem 12 and capillary element 4.

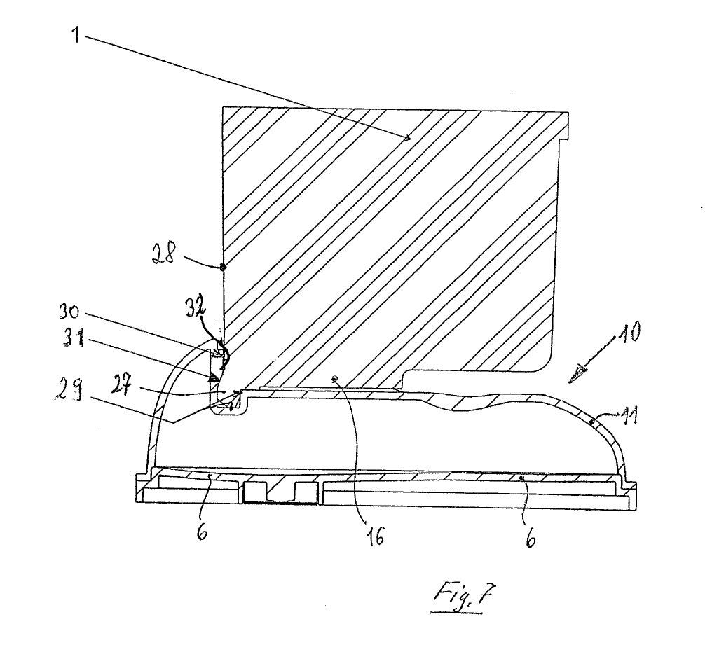

Referring to FIG. 7, a refilling device matched to a special ink cartridge will now be described, parts that have already been described with reference to FIGS. 1 to 6 being given the same reference numerals. Accordingly, the device 10 according to FIG. 7 is a device for refilling an ink cartridge 1 having a locking projection 27 on a corner of an end face, more specifically on the corner between the integrated print head 16 and the directly adjoining end face 28 of the ink cartridge 1. For that purpose, the ink container 11 has on its docking side, that is to say the upper side, a depression 29 complementary to the cartridge projection 27, into which depression the cartridge-side corner projection 27 can be inserted or clicked-in or latched-in during docking and from which it can be correspondingly released on removal of the cartridge 1 from the ink container 11. By insertion or clicking-in or latching- in into the depression 29, the ink cartridge 1 can be precisely positioned and mounted with respect to the capillary element 4. The corresponding depression 29 is formed in the end-face corner region of the trough-like depression 26, as can be seen in FIG. 7.

In the embodiment shown, the container-side depression 29 is also associated with a stop rib 30 having a clamping surface 31 extending obliquely into the depression 29, so that the ink cartridge 1 is positioned and mounted essentially only by the clamping action of its corner projection 27 inside the associated depression 29 in the ink container 11 (see FIG. 7).

The stop rib 30 co-operates both with the end face 28 and with the upper side of the corner projection 27 of the ink cartridge 1.

Preferably, the container comprises two stop ribs 30, one on each side of the trough-like depression 26 in accordance with FIG. 1. In between, a further central support rib 32 can be provided which acts against the end face 28 of the ink cartridge and forces the latter against the capillary element 4, more specifically in the direction of arrow 33 in FIG. 7.

As already mentioned at the beginning, the ink container 11 can have two or more chambers for holding ink of different colors and/or consistencies and capillary elements associated with those chambers, the capillary elements being arranged one next to the other so that they can each be brought into contact only with the respective color nozzles of a print head or color-outlet openings of an ink cartridge being refilled.

Alternatively, in the case of a multicolor ink cartridge having a print head and nozzles, the nozzles each being associated with certain colors, or having a plurality of outlets for the individual colors, it would also be possible to provide a set of at least two ink containers (11) having a capillary element (4), the capillary elements being arranged at different positions in accordance with the color-associated nozzles or ink outlet openings of the ink cartridge.

All the features disclosed in the application documents are claimed as being important to the invention, provided that they are novel over the prior art, either individually or in combination

Reference numerals: 1 ink cartridge 2 underside of the ink cartridge or underside of the integrated print head 3 compression spring 4 capillary element (wick or wick pad) 5 connecting duct 6 base 7 air-inlet opening 8 (air-inlet) valve 9 (ink outlet) valve 10 refilling device 11 ink container 12 valve stem 13 valve body 14 valve body or valve disc 15 peripheral rib 16 print head 17 ink outlet 18 receiving opening for capillary element 19 ink 20 air-outlet channels 21 positioning surface 22 peripheral rib 23 peripheral groove 24 peripheral gap 25 base 26 trough-like depression 27 locking projection 28 end face of the ink cartridge 29 depression 30 stop rib 31 clamping surface 32 support rib

1. Device (10) for refilling an ink cartridge (1) for an inkjet printer, having a print head (16) comprising nozzles or having an ink outlet opening couplable to the ink supply of an inkjet head, either the nozzles of the print head (16) being directly in fluid connection or, in the case of an ink outlet opening couplable to the ink supply of an inkjet head, the ink outlet opening being in fluid connection, by way of a wick and/or a valve or a direct fluid connection, with an ink reservoir element arranged inside the ink cartridge and comprising, for example, absorbent material or a mechanism that generates negative pressure, the device comprsing:
an ink-filled container (11) with an air-inlet opening (7) and a further opening (18), through which there extends a capillary element (4) which is arranged to be brought into fluid connection the ink (19) in the container (11) and to which the ink cartridge (1) or the ink reservoir element thereof is dockable, with establishment of a capillary fluid connection,
the air-inlet opening (7) provided in the ink container (11) is openable only on docking of the ink cartridge (1), and
the ink container (11) has an ink outlet (17) to the capillary element (4), and said outlet is openable only on docking of the ink cartridge (1).

2. Device according to claim 1, wherein both the air-inlet opening (7) and the ink outlet (17) are each associated with a respective valve (8, 9), the valves are actuatable by docking of the ink cartridge (1).

3. Device according to claim 2, wherein the valve (8) associated with the air-inlet opening (7) and the valve (9) associated with the ink outlet (17) have a common valve stem (12) having a valve body (13) associated with the air-inlet opening (7) and a valve body (14) associated with the ink outlet (17) so that, on docking of the ink cartridge (1), actuation of the valve stem (12) causes the two valve bodies (13, 14), either simultaneously or in succession, to unblock and open the air-inlet opening (7) and the ink outlet (17), or vice versa on removal of the ink cartridge (1) from the capillary element (4).

4. Device according to claim 3, wherein the valve stem (12) is movable from a valve closure position to a valve opening position against a force of a resilient element comprising a helical compression spring (3).

5. Device according to claim 3, wherein the valve body associated with the ink outlet (17) is a valve disc (14) made of resiliently flexible material.

6. Device according to claim 5, wherein a peripheral rim of the resiliently flexible valve disc (14) is associated with a peripheral rib (15) inside the ink outlet (17), and before a first use of the device, i.e. before the first actuation of the valve (9) associated with the ink outlet (17), the peripheral rim of the valve disc (14) rests sealingly against a side of the peripheral rib (15) facing the ink cartridge docking side of the ink container (11), and after use or after removal of a refilled ink cartridge (1) rests sealingly against an opposite side of the peripheral rib (15), with in each case with the valve disc (14) bulging very slightly into the ink outlet opening (17) bounded by the peripheral rib (15).

7. Device according to claim 1, wherein the ink outlet (17) is arranged on an underside or in the base (6) of the ink container (11) and is arranged to be brought into fluid connection with the capillary element (4) by a base-side duct (5).

8. Device according to claim 1, wherein the capillary element (4) is associated with at least one air-outlet channel (20).

9. Device according to claim 8, wherein a plurality of the air-outlet channels (20), distributed approximately uniformly around a periphery of the capillary element (4), are provided inside a receiving opening (18) for the capillary element (4).

10. Device according to claim 1, wherein the capillary element (4) is decoupled from capillary action from the ink cartridge positioning surface (21) bounding it, by a peripheral rib (22) between a peripheral, groove-like depression (23) and a gap (24) extending around the capillary element (4).

11. Device according to claim 1, for the refilling of an ink cartridge (1) which further comprises a locking projection (27) on a corner of an end face, on the corner between the integrated print head (16) and a directly adjoining end face (28) of the ink cartridge (1), the device further comprising a depression (29) on the ink container (11) on a docking side thereof, the depression (29) is complementary to the cartridge-side corner projection (27), with the cartridge-side corner projection (27) being insertable into the depression by latching during docking and from which it is releasable on removal of the cartridge (1) from the ink container (11) or the capillary element (4) thereof.

12. Device according to claim 11, wherein the container-side depression (29) is associated with at least one stop rib (30) having a clamping surface (31) extending obliquely into the depression (29), so that the ink cartridge (1) is positioned and mounted essentially only by the clamping action of the corner projection (27) inside the associated depression (29) in the ink container (11).

13. Device according to claim 1, wherein the base (6) of the container (11) comprises a gravitation base that slopes towards the ink outlet (17).

14. Device according to claim 1, wherein the capillary element is constructed as a wick or wick pad (4).

15. Device according to claim 1, wherein the capillary element (4) extends through a base (25) of a trough-like depression (26) on an upper side of the ink container (11).

16. Device according to claim 3, wherein the valve stem (12) associated with the air-inlet opening (7) and/or the ink outlet (17) extends through the ink cartridge positioning surface (21) including a base (25) of a trough-like depression (26) on an upper side of the ink container (11), in such a way that, on docking of the ink cartridge (1) to the capillary element (4), the valve stem is movable into the valve opening position, or vice versa on removal of the ink cartridge (1) from the capillary element (4).

17. Device according to claim 1, wherein the ink container (11) has at least two chambers for holding ink of different colors and capillary elements associated with the chambers, the capillary elements being arranged one next to the other so that they can each be brought into contact only with respective color nozzles of a print head or with respective colored ink outlet openings of an ink cartridge (1) being refilled.

18. Device according to claim 1, wherein for an a multicolor ink cartridge having an integrated print head and nozzles, the nozzles each being associated with certain colors, or having a plurality of ink outlet openings for the individual colors, there is provided a set of at least two ink containers (11) each having a respective one of the capillary elements (4), the capillary elements (4) being arranged at different positions in accordance with the color-associated nozzles or ink outlet openings of the ink cartridge (1).
